(19) United States
(12) Patent Application Publication
(10) Pub. No.: US 2012/0218924 A1
(43) Pub. Date: Aug. 30, 2012

(54) QUALITY OF SERVICE (QOS) OVER NETWORK-TO-NETWORK INTERFACES FOR IP INTERCONNECTION OF COMMUNICATION SERVICES

(75) Inventor: Rajesh Bhalla, Gahanna, OH (US)

(73) Assignee: ZTE (USA) INC., Morristown, NJ (US)

(21) Appl. No.: 13/394,131

(22) PCT Filed: Sep. 6, 2010
(86) PCT No.: PCT/US10/47934

§ 371 Date: May 15, 2012

Related U.S. Application Data
(60) Provisional application No. 61/240,187, filed on Sep. 4, 2009.
(60) Provisional application No. 61/241,618, filed on Sep. 11, 2009.

(51) Int. Cl. H04L 12/66; H04W 92/02

(52) U.S. Cl. 370/310; 370/400

(57) ABSTRACT

Techniques, apparatuses, and systems can include mechanisms to provide end-to-end quality-of-service.

### PRIORITY CLAIMS AND RELATED PATENT APPLICATIONS

This patent document claims the benefits and priorities of the following two U.S. provisional applications filed in U.S.: (1) U.S. Provisional Patent Application No. 61/240,187, filed on Sep. 4, 2009, entitled “QOS ACROSS NETWORK-TO-NETWORK INTERFACES FOR IP INTERCONNECTION OF SERVICES IN WIRELESS COMMUNICATIONS,” (2) U.S. Provisional Patent Application No. 61/241,618, filed on Sep. 11, 2009, entitled “QOS ACROSS NETWORK-TO-NETWORK INTERFACES FOR IP INTERCONNECTION OF SERVICES IN WIRELESS COMMUNICATIONS.”

The entire disclosures of the above referenced applications are incorporated by reference as part of this document.

### BACKGROUND

This document relates to communication techniques and systems, including techniques and systems for wireless communications and wired communications.

In packet switched networks where data packets are delivered via wired or wireless communication links or networks, the quality of service (QoS) is implemented to reserve communication resources and to control delivery of data packets to achieve a certain level of performance in delivering the data packets. The level of the QoS performance can be measured by one or more parameters, e.g., the transmission bit rate, the transmission delay, the packet data jitter, the probability of loss of data, the bit error rate. Certain data services may be tolerant to delays and packet drops while certain data services, such as voice over IP, interactive data services, video and multimedia data services, can be highly sensitive to delays and packet drops and thus require a high level of QoS.

QoS mechanisms can be implemented for controlling and managing packet delivery via wired or wireless communication links or networks based on packet switching to meet certain QoS requirements. Wireless communication systems can include a network of one or more base stations to communicate with one or more wireless devices such as a mobile device, cell phone, wireless air card, mobile station (MS), user equipment (UE), access terminal (AT), or subscriber station (SS). Each base station can emit radio signals that carry data such as voice data and other data content to wireless devices. A base station can be referred to as an access point (AP) or access network (AN) or can be included as part of an access network. Further, wireless communication systems communicate with each other or with wireline communication systems via one or more core networks. A wireless device can use one or more different wireless technologies for communications. Various wireless technologies examples include Code division Multiple Access (CDMA) such as CDMA2000 1x, High Rate Packet Data (HRPD), Global System for Mobile communications (GSM) based technologies, Long-Term Evolution (LTE), orthogonal frequency-division multiplexing (OFDM), and Worldwide Interoperability for Microwave Access (WiMAX). In some implementations, a wireless communication system can include multiple networks using different wireless technologies.

In various communication applications, data communication services based on packet switching are provided across two or more communication networks that may be operated by different network carriers or operators. It is desirable to implement QoS mechanisms over network to network interconnections in such applications to achieve desired levels of data deliver performance.

### SUMMARY

This document describes technologies, among other things, for wireless and wireline communications.

In one aspect, technologies for communications between wireless and/or wireline communication systems can include methods and apparatuses and systems for enabling end-to-end QoS over Network to Network Interfaces (NNI) to provide IP Multimedia Services (IMS).

In another aspect, a method for providing quality of service (QoS) in packet data communications via different communication networks is provided to include:

providing QoS service managers in different communication networks, respectively, to manage QoS signaling in the different communication networks over network-to-network interconnections connecting the different communication networks;

operating the QoS service managers of two interfacing different communication networks to communicate with each other to enable each QoS service manager to obtain QoS information of a Service Level Agreement (SLA) for a data communication service supported by the different communication networks and information on network communication resource in a respective communication network;

providing a border gateway in each communication network to interface with another interfacing communication network for signaling and data communications between the two interfacing communication networks, wherein a communication network interfacing with two other communication networks, if exists, has two border gateways that are designated to interface with the two other communication networks, respectively;

operating each QoS service manager to communicate to one or more border gateways in a respective communication network information on QoS policy for the data communication service including the QoS information of the SLA and the information on network communication resource for the data communication service; and operating each border gateway as a QoS policy enforcement entity to enforce the QoS policy.

These and other aspects and their implementations are described in detail in the description, the drawings and the claims.

### BRIEF DESCRIPTION OF DRAWINGS

FIGS. 1 and 2 show examples of a wireless RF network and a wireless radio transceiver in connection with described QoS techniques and systems.

FIG. 3 shows a high level IP eXchange (IPX) Architecture model.

FIG. 4 shows an example of an IPX architecture by Europe's TISPAN (Telecommunications and Internet converged Services and Protocols for Advanced Networking).

FIG. 5 shows an example of Public Switched Telephone Network (PSTN) and Public Land Mobile Network (PLMN) Carrier Interconnects Over a Network-to-Network Interface (NNI).

FIG. 6 shows an example of an IPX architecture for guaranteeing end to end (E2E) QoS Over NNI for Remote Carrier Access.

FIG. 7 shows an example of an IPX architecture for providing E2E QoS Over NNI For Multi Device Access where a user subscribes to home broadband and premium video services from Home Provider A.

FIG. 8 shows an example of a proposed scalable IPX architecture that guarantees E2E QoS.

FIG. 9 shows an example of E2E QoS Guarantee Call Flows for the IPX architecture in FIG. 8.

FIGS. 10 and 11 show exemplary implementations of the call flows in FIG. 9.

### DETAILED DESCRIPTION

Communication networks, such as packet based networks, can connect different wireless and wireline communication systems. Such communication systems can provide different service levels and quality-of-service (QoS) to users. Networks such as wireless and wireline communication systems and packet based networks can provide end-to-end (E2E) QoS for various connections.

An Network-to-Network Interface (NNI) defines how two networks interconnect and exchange information. QoS over NNI interconnect is important for optimal network utilizations and for delivering high quality services economically. Traditionally, some carriers have addressed the issue of QoS by over-provisioning of their networks. However, with the increasing volume of time-division-multiplexing (TDM) traffic being migrated to Internet Protocol (IP) based networks, and with the increasingly uptake of IP based services such as multimedia services; it may not be possible or difficult to dimension networks to effectively meet peak traffic requirements. Hence, QoS over NNI is an important topic of study in major Standards Development Organizations (SDOs).

Issues related to QoS over NNI are being debated actively in various industry forums. GSM Association (GSMA) uses its General Packet Radio Service Roaming Exchange (GRX) model to define an IP eXchange (IPX) interconnect model that extends GRX by including QoS capabilities. Two other SDOs, the 3rd Generation Partnership Project (3GPP) and ETSI TISPAN (Telecommunications and Internet converged Services and Protocols for Advanced Networking), have undertaken approaches to address the QoS problem. IPX uses enhanced QoS features and various elements and principles already used commercially in GRX to guarantee performance, quality and security of IP-based data services. IPX adds support for differentiated services (DiffServ) to GRX by using Differentiated Services (DiffServ) techniques where data services are differentiated based on classification of data packets into various classes of service. The class of service (CoS) of each packet is used in IPX to allocate the priority and network resources to forwarding the respective packet with respect to other data packets. IPX defines a Type of Service (TOS) field with DiffServ Code Point (DSCP) in the IP header of a data packet to allow different packets to be handled differently based on the priority information based on the CoS classification of the different data packets. Limitations due to the static configuration of edge routers in DiffServ could, however, result in under-provisioning or over-provisioning of network resources.

The techniques and systems for QoS mechanisms across different networks described in this document can be implemented in ways for providing, e.g., E2E QoS guarantees for an IPX differentiated service model. Implementations can provide an E2E solution for the enforcement of dynamic and multi-level chain of Service Level Agreements (SLAs) and provide E2E QoS guarantees. Implementations can be based on inter-domain NNI signaling for the exchange of Policy Rules amongst Policy Decision Point (PDP) entities in provider domains. In some implementations, intra-domain QoS Rules signaling can be performed between PDP and Border Gateways at the edge of respective domains for policy enforcement. DiffServ markings on class based trunks can be used for identifying different classes of traffic and for enforcing class-specific policies. Certain implementations can include mechanisms for providing QoS between wireless and/or wireline communication systems. The present techniques and systems can also be implemented in ways that enable end-to-end QoS over Network to Network Interfaces (NNI) to provide IP Multimedia Services (IMS). Examples are provided in this document for an architecture to permit Service Providers and IPX Providers to handle differentiated services in a coordinated manner and to guarantee QoS over NNI E2E in a reliable fashion.

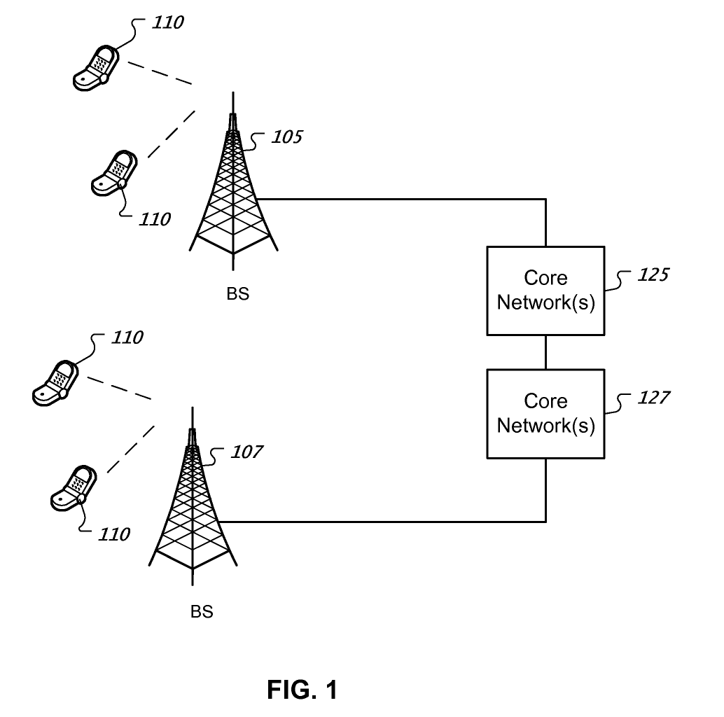

The data delivery in connection with the techniques and systems for QoS mechanisms across different networks can be via wireless communication links such as wireless RF links or wired communication links such as cables or optical fibers. The wireless RF links can be implemented in various configurations based on various wireless technologies. FIGS. 1 and 2 show examples of a wireless RF network and a wireless radio transceiver.

FIG. 1 shows an example of a wireless communication system for providing radio access to wireless devices or users. In this example, the communication system can include one or more base stations (BSs) 105, 107 and one or more wireless devices 110. A base station 105, 107 can transmit a signal on a forward link (FL), called a downlink (DL) signal, to one or more wireless devices 110. A wireless device 110 can transmit a signal on a reverse link (RL), called an uplink (UL) signal, to one or more base stations 105, 107. The wireless communication system can include one or more core networks 125, 127 to control one or more base stations 105, 107. Examples of wireless communication systems that can implement the present techniques and systems include, among others, wireless communication systems based on Code division Multiple Access (CDMA) such as CDMA2000 1x, High Rate Packet Data (HRPD), Global System for Mobile communications (GSM) based technologies, Long-Term Evolution (LTE), Universal Terrestrial Radio Access Network (UTRAN), and Worldwide Interoperability for Microwave Access (WiMAX).

Multiple wireless and/or wireline communication systems can interconnect to provide E2E QoS for wireless communications. In some implementations, core networks 125, 127 can use different modes to transport data between different wireless and/or wireline communication systems.

FIG. 2 shows an example of a radio station architecture. Various examples of radio stations include base stations and wireless devices. A radio station 205 such as a base station or a wireless device can include processor electronics 210 such as a microprocessor. A radio station 205 can include transceiver electronics 215 to send and/or receive wireless signals over one or more communication interfaces such as one or more antennas 220. A radio station 205 can include other communication interfaces for transmitting and receiving data. In some implementations, a radio station 205 can include one or more wired communication interfaces to communicate with a wired network. A radio station 205 can include one or more memories 225 configured to store information such as data and/or instructions. In some implementations, processor electronics 210 can include at least a portion of transceiver electronics 215 and a memory 225.

In some implementations, radio stations 205 can communicate with each other based on a CDMA air interface. In some implementations, radio stations 205 can communicate with each other based on an orthogonal frequency-division multiplexing (OFDM) air interface which can include Orthogonal Frequency-Division Multiple Access (OFDMA) air interface. In some implementations, radio stations 205 can communicate using one or more wireless technologies such as CDMA such as CDMA2000 1x, HRPD, WiMAX, LTE, and Universal Mobile Telecommunications System (UMTS).

### QoS Over Network-to-Network Interface

Network-to-Network Interface (NNI) defines how two networks interconnect and exchange information. While the interconnected network domains are external to each other and typically operated by different carriers, such interconnected networks can include separate internal domains as well. Quality of Service (QoS) for such NNI connected IP networks relates to the upper limit on end-to-end (E2E) packet delay, upper limit on packet loss and packet transfer delay variation (jitter), and attributes such as bandwidth profiles, traffic classification and availability requirements defined in Service Level Agreements (SLAs). QoS over NNI relates to the capability of differentiating classes of services (CoS) and the ability to assign corresponding QoS guarantees in terms of bandwidth allocations and traffic characteristics across interconnected carrier domains.

Some prior IP networks achieved QoS guarantees by relying on reserving large bandwidths and this approach caused low network capacity utilizations. Better leveraging of network resources for enhanced user experience is important to carriers even when adequate bandwidth resources are available. With more and more networks moving towards all IP-based network architectures, service providers are increasingly looking for solutions for optimal network utilizations and cost reductions for network interconnections. Quality of Services for IP-based telecom services, therefore, can play a vital role for Network-to-Network Interconnections.

QoS over Network-to-Network Interconnections have been investigated by the telecom industry and standards organizations (SDOs) such as 3rd Generation Partnership Project (3GPP), TISPAN (Telecommunications and Internet converged Services and Protocols for Advanced Networking), GSM Association (GSMA)

Major SDOs have defined NNI interface and related network elements. Some SDOs have defined QoS functions as well. The following is a high level synopsis of the major SDO's efforts regarding QoS over NNI.

### GSMA:

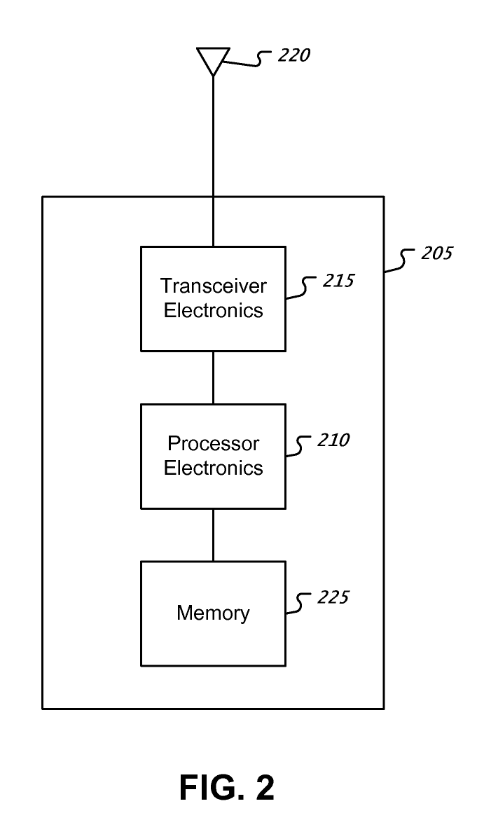

GSMA has defined an architectural framework for IP Packet eXchange (IPX) based on GRX (GPRS Roaming eXchange), as documented in “Inter-Service Provider IP Backbone Guidelines” (GSMA IR.34). FIG. 3 shows a high level IPX Architecture model where different network operators A, B and C are illustrated.

IPX allows various types of Service Providers—Mobile Network Operators (MNOs), Fixed Network Operators (FNOs), Internet Service Providers (ISPs) and Application Service Providers (ASPs)—to obtain connections to Inter-Service Provider IP Backbone (IPX) using local tail connections. A local tail may be implemented via Layer 1 physical connections, logical connections at Layer 2 or Layer 3 IP VPN connections over the public IP network; though Layer 3 connectivity is not the recommended option. Service Providers may connect to more than one IPX Provider. IPX is formed from separate and competing IPX Providers.

IPX Interconnect supports three types of connectivity options: Transport-Only Connectivity, Bilateral Service Transit Connectivity and Multilateral Service Hub Connectivity. IPX supports end-to-end (E2E) Quality of Service—from the originating Service Provider Border Gateway to the terminating Service Provider Border Gateway. IPX Proxy functions in the later two types of connectivity options facilitate IPX Providers to ensure E2E QoS for all traffic classes as per Service Level Agreements.

In IPX, E2E QoS is built on Class of Services (CoS) and QoS Profiles defined in the Service Level Agreements (SLAs). SLAs define service specifications between a Service Provider and an IPX Provider, and also between two IPX Providers. Service availability, jitter, packet loss and delay are the metrics included in the QoS Profiles. Such QoS metrics need to be supported over an individual connection between a Service Provider and an IPX Provider. This SLA can extend to the whole IPX network as well, comprising of multiple IPX Providers. The Border Gateways at the Source and Destination Service Providers are the demarcation points for the measurement/enforcement of the agreed upon QoS Profiles. In order to ensure E2E QoS; GSMA IR.34 recommends Traffic Classification and DiffServ markings of Service Provider traffic as shown in TABLE 1 below. The 6-bit DSCP marking indicates the Per Hop Behavior (PHB) that belongs to each traffic class as recommended in IETF RFC3246 and RFC2597 standards by the Internet Engineering Task Force (IETF).

TABLE 1
Traffic Classification and DSCP Markings

| QoS Information | | DiffServ | DSCP | |
|---|---|---|---|---|
| Traffic Class | THP | PHB | Marking | Typical Applications |
| Conversational | N/A | EF | 101110 | VoIP, Video Share |
| Streaming | N/A | AF41 | 100010 | Push to Talk, Video |
| | | | | Streaming |
| | 1 | AF31 | 011010 | Online Gaming, |
| | | | | Signaling Traffic |
| Interactive | 2 | AF21 | 010010 | WEB browsing |
| | 3 | AF11 | 001010 | Instant Messaging |
| Background | N/A | BE | 000000 | Email, MMS |

(“EF”—Expedited Forwarding, “AF”—Assured Forwarding, and “BE”—Best Effort)

Conversational traffic class imposes strict requirements on delay and jitter values. For streaming traffic class, the requirements are not as tight as the user equipment normally buffers data before play out. Interactive class of traffic requires bandwidth reservation to meet service requirements. For background traffic class, the packet size is usually large, though not delay and jitter sensitive. Packet drop is minimized to avoid retransmissions and extra load on the network. Service Providers mark the packets according to traffic classification rules before forwarding the traffic to IPX Provider. Queuing, packet treatment algorithms and other techniques that might be used with the DiffServ are a decision let to the IPX Providers. Such traffic classification is based on an aggregate of user traffic flows that belong to the same class. Traffic belonging to different classes is DSCP marked and sent to the IPX Provider, possibly encapsulated in generic routing encapsulation (GRE) tunnels. The IPX Provider may remark DSCP values for routing within their own domains, as long as they return the original DSCP markings at the egress point of their respective domains.

### ETSI TISPAN:

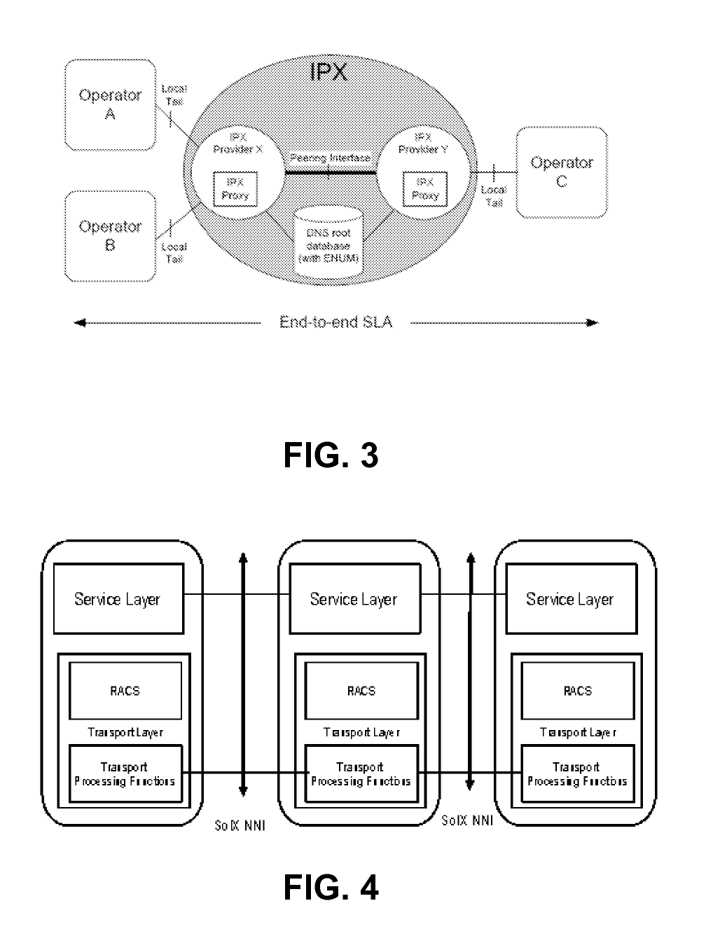

TISPAN IPX is a standard by European Telecommunications Standards Institute (ETSI) provides a TISPAN defined IP backbone network to support connectivity between Service Providers. FIG. 4 shows an example of a TISPAN IPX architecture including an example of an Indirect SoIx Interconnection.

There is no mandatory support for E2E QoS in TISPAN IPX framework. TISPAN IPX covers three GSMA IPX types of interconnections viz. Transport-Only Connectivity, Bilateral Service Transit Connectivity, Multilateral Service Hub Connectivity. For providing E2E QoS, such commonality with GSMA IPX could further the scope of a converged solution in different SDOs.

### 3GPP:

3GPP has been studying the technical requirements for inter-operator IP Interconnections to support IMS Multimedia services and for legacy voice and video services by Public Switched Telephone Network (PSTN) and Public Land Mobile Network (PLMN) that are transported over IP infrastructure (e.g., VoIP) (TR 22.893). The study has taken into account the interconnect models being defined by other bodies e.g., GSMA, ETSI and ITU-T.

3GPP TR 22.893 has identified three interconnect scenarios: Inter-Operator Direct Connection, Inter-Operator Indirect Connection and Operator to 3rd Party Connection. Inter-Operator Indirect Connection envisages IP connection between Service Providers via. IP-Interconnection Intermediate Carrier such as IPX. Operator to 3rd Party Connection is a special case of indirect-connection scenario and supports Service Provider interconnection to Application Provider(s) using interconnects such as IPX.

3GPP TR 22.893 IPX model expands the focus from just transport and connectivity approach of GRX to service-aware interconnection by the use of proxy functions in interconnected networks. Interconnection points are uniquely identified by means of SLAs. The interconnections support E2E QoS by differentiating and marking classes of traffic. Signaling and media traffic are treated according to their markings in order to guarantee adequate E2E QoS. This is very much in line with the approach taken by GSMA IPX Guidelines in IR.34.

### ATIS:

The Next-Gen Carrier Interconnection (NG-CI) working group in ATIS has defined a number of use cases and the QoS requirements over NNI for interconnection scenarios, including mechanisms for QoS for VoIP, Video Conferencing, Data, and IPTV. There have been proposals in ATIS on application scenarios based on the concept of an IP Proxy network which acts as 3rd party network to provide interconnection for two service providers serving as the originating and terminating parties.

### IETF:

IETF has defined solutions for guaranteeing QoS over NNI for Multiprotocol Label Switching (MPLS) networks by combining DiffServ and RSVP-TE which is the Resource Reservation Protocol (RSVP) for traffic engineering (TE). DiffServ distinguishes Class of Service (CoS) per packet, allocates priority and ensures precedence in forwarding packets for higher priority services. However, DiffServ cannot schedule bandwidth for different class of services. In the event of traffic exceeding the available bandwidth, DiffServ can guarantee precedence for higher priority services at the expense of lower priority services. In the extreme circumstances, even high priority services are not immune to latency and packet loss. Therefore DiffServ technology alone, as defined for IPX networks, does not guarantee E2E QoS and Service Level Agreements.

IETF defined RSVP-TE protocol reserves the resources to ensure routing paths against congestion and thus guarantees bandwidth resources for defined service classes. RSVP-TE does not have service identification capability. QoS sensitive services are affected once the traffic in the MPLS tunnel exceeds reserved traffic rate. Therefore, RSVP-TE alone cannot solve the E2E QoS guarantee problem either.

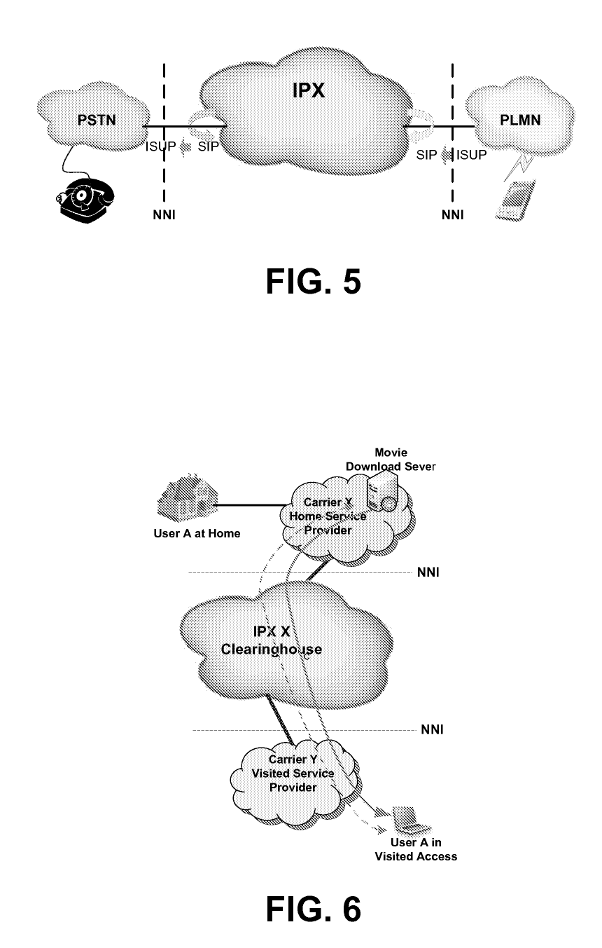

Combining DiffServ and RSVP-TE technologies enables MPLS IP core networks to distinguish CoS, ensures resource reservation based on CoS and forwarding precedence for higher priority services. Therefore, combining DiffServ and RSVT-TE technologies can guarantee E2E QoS and Service Level Agreements over NNI for MPLS based core networks. FIG. 5 shows an example of PSTN and PLMN Carrier Interconnects Over NNI. In this example, a PSTN Carrier and a PLMN Carrier are interconnected via an IP-Interconnection Intermediate Carrier (IPX Carrier) which is an all IP network. PSTN Carrier and PLMN Carrier both have SLAs in place with the IPX Carrier respectively but no direct SLA between the PSTN and the PLMN carriers exists. IPX Carrier provides transport-only services, wherein the IPX simply relays IP traffic from one carrier to the other. In addition the IPX converts TDM traffic to IP traffic as required before relaying it. Session Initiation Protocol (SIP) was defined by the IETF (Internet Engineering Task Force) specifically for IP networks in 1999 (RFC 2543) as an application layer signaling protocol for establishing, modifying and terminating of IP-based sessions, e.g., Internet telephone calls, multimedia distribution, and multimedia conferences, with one or more participants. IPX supports different SIP Profiles, and provides conversion/interoperability between SIP Profiles.

When a PLMN User makes a call terminating to a PSTN User and vice versa, the IPX carrier provides DiffServ based differentiated services for ensuring E2E QoS. The IPX Proxy in IPX carrier domain provides services such as time of the day routing, blacklist checking, transcoding, and SIP and ISUP conversions over the NNI based on the policy information in the SLAs it has with the PSTN and PLMN carriers.

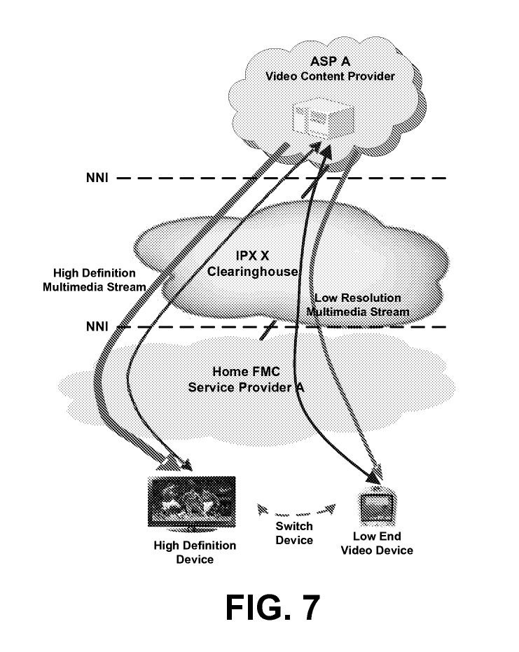

FIG. 6 shows an example of an IPX architecture for guaranteeing E2E QoS Over NNI for Remote Carrier Access. Carrier X is User A's home service provider. User A subscribes for home broadband and premium video services from Carrier X. Carrier X hosts movie/video download servers or contracts such services from some 3rd Party content providers—but that is transparent to the User. The subscription of User A allows him to obtain such premium services while roaming in Carrier X partner networks as well. Carrier Y is one such roaming partner of Carrier X. For the sake of discussions it is assumed Carrier Y is a WLAN service provider with hotspots across the country. Carrier X and hotspots of Carrier Y, all subscribe to the IPX X Clearinghouse to enable seamless service experience for Carrier X users. Carrier X and Carrier Y interface with the IPX X Clearinghouse via IPX NNI interconnects. Both Carrier X and Carrier Y have SLAs in place with the IPX X for guaranteeing QoS to the Users.

User A leaves home and obtains internet connectivity for his laptop device via Carrier Y WLAN hotspot network in a coffee shop. User A wants to watch sports clips by logging on to his home (Carrier X) video portal (via SIP signaling etc.). Carrier X recognizes User A's premium subscription status and invokes SLA with IPX X Clearinghouse to enable high bandwidth streaming services via DiffServ class markings (e.g., DiffSev marking of AF4x) of User A media packet streams. IPX X Clearinghouse honors DiffServ markings on User A's media streaming packets at its ingress Border Gateway according to the SLA with Carrier X. However, in the current IPX paradigm there is nothing to guarantee that such premium QoS services will be guaranteed to the User A's media streaming packets E2E while connected via Carrier Y network.

The QoS over NNI techniques described in this document can be implemented to provide the ability of guaranteeing E2E QoS over NNI interconnects. This implementation allows the an adequate bandwidth and other resources in the IPX X domain to be reserved so that User A can receive high throughput media streaming services while being connected in Carrier Y networks.

QoS mechanisms are described in this document for providing guarantees for such E2E QoS over NNI interconnects. In some implementations, the mechanisms can include inter-domain NNI signaling for the reservation of resources in the IPX domain, and intra-IPX domain signaling for the enforcement of the QoS E2E.

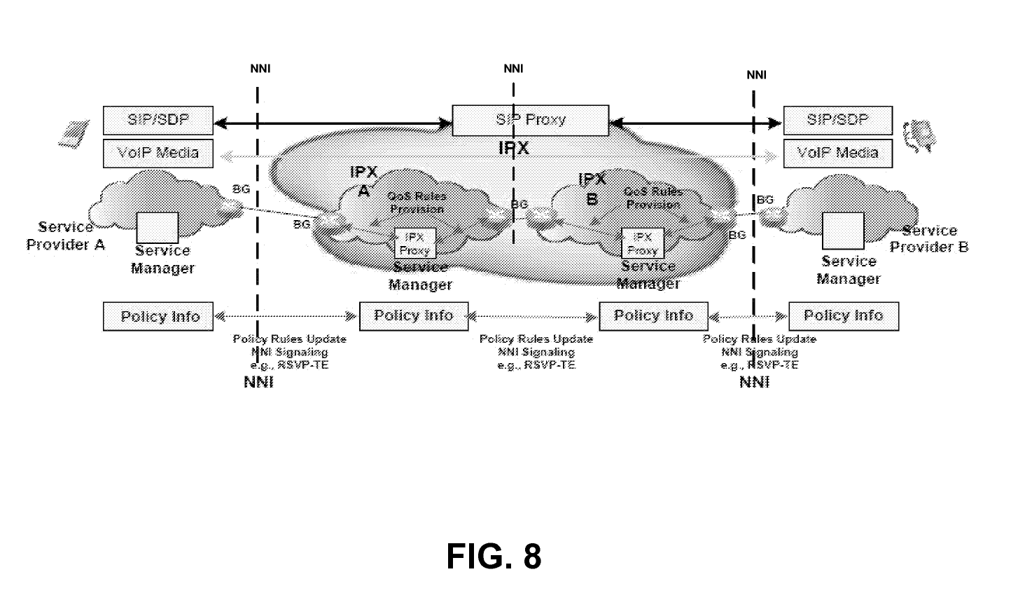

FIG. 7 shows an example of an IPX architecture for providing E2E QoS Over NNI For Multi Device Access where a user subscribes to home broadband and premium video services from Home Provider A. Provider A is an Fixed mobile convergence (FMC) provider and provides services via landline and wireless broadband access. The User can access services via a multitude of devices with varying media capabilities. For example, the User has a high resolution multimedia device (e.g., a HDTV) and a low resolution video device (e.g., a wireless device). Home Provider A channels content to the User from multiple content providers. In the illustrated example, ASP A is an Application Service Provider providing IPTV video content. Home Provider A and ASP A maintain connectivity via an IPX Clearinghouse. Home Provider A and ASP A maintain SLAs with the IPX Clearinghouse for guaranteeing QoS to the Users.

In the scenario under consideration, the User initially watches IPTV via his wireless device. When the User initiates the IPTV session from his wireless device using the SIP protocol, Home Provider A and ASP A recognize access device capabilities and determine that the user device supports low resolution multimedia streaming only. ASP A encodes and modulates the media streams according to User wireless device's recognized capabilities. It is assumed that a solution exists for the Provider A or ASP A to communicate to IPX X, bandwidth requirements and traffic characteristics for transporting the media streams to the User. It is also assumed that capabilities exist for the IPX X to communicate with its edge-routing functions (Border Gateways) for the enforcement of the agreed upon bandwidth and traffic characteristics for the User directed media streams while the User media stream is transported over the IPX X domain.

Next, the User switches to the high resolution multimedia device. Home Provider A and ASP A again recognize access device capabilities of the high resolution multimedia device. ASP A now encodes and modulates the media streams according to high resolution multimedia capabilities of the user device. It is assumed that a solution exists for the Provider A or ASP A to communicate to IPX X the increased bandwidth and enhanced traffic characteristics requirements for transporting high resolution media streams to the User. IPX X, in turn, communicates such enhanced requirements to its edge-routing functions (Border Gateways) for appropriate policing and shaping of the User directed media streams at the ingress and egress points of the IPX X domain. Under the above circumstance, E2E QoS for the user media streams can be guaranteed while the media streams are transported over the IPX X domain. IPX X domain may include one or more IPX Providers, and such E2E QoS guarantees are provided across such multi IPX provider domains.

Architectures for E2E QoS Over NNI

Industry momentum has been building around GSMA IPX. 3GPP SA1 has also been working on “Study into Identification of Advanced Requirements for IP Interconnection of Services” (3GPP TR 29.893) and endorses GSMA IPX. GSMA IPX proposes differentiated services by using DiffServ techniques. However, providing differentiated services in IPX networks is challenging because of the scaling problems presented by the sheer number of flows. Coupled with this, IPX Providers need the ability to perform traffic conditioning on the flows belonging to different classes. Though several solutions for guaranteeing QoS in intra-Service Provider domain have been defined e.g., 3GPP Policy and Charging Control (PCC), ETSI TISPAN RACS Resource Admission Control Subsystem (RACS) etc., such solutions are not applicable for E2E QoS over inter-domain NNI interconnects.

A scalable IPX architecture is proposed here to enable Service Providers and IPX Providers to craft inter-domain Service Level Agreements for handling differentiated services in a coordinated manner and to guarantee E2E QoS over NNI in a reliable fashion. The functional elements and interfaces for this scalable IPX architecture are provided in detail below.

GSMA IPX utilizes DiffServ for traffic conditioning and policing based on the static configuration of Border Gateways (BGs). This use of DiffServ can lead to undesired under-provisioning or over-provisioning of network resources. To support guaranteed E2E differentiated services, in one implementation, the proposed scalable IPX architecture can be configured to allow the Service Providers to separate packet flows into different “traffic classes” before the traffic enters IPX Provider networks. After this classification, packet flows are aggregated according to their traffic classes and the aggregated flows are tunneled for transport over the IPX networks. Such class based aggregates of flows are referred to as ‘trunks.”

Service Provider(s) and IPX Provider(s) have SLAs to support differentiated services. Correspondingly, different providers within the IPX also have their respective SLAs. Without going into the details on the content of the SLAs, it can be assumed that the SLAs can be crafted to include the types of differentiated services that one Provider provides to the other Provider, as well as the upper bound on the amount of traffic associated with each such “traffic class” that the provider will be willing to accept and carry from the other provider. The SLAs can be enforced by the receiving carrier/provider based on DiffServ markings on the aggregated traffic trunks.

As an example, in some implementations, egress traffic from Service Provider Border Gateways (BWs) can be classified into class based trunks—such as Best Effort, Priority, Mission Critical trunks. Such classification could be based on specific requirements associated with the trunks, such as the priority for bandwidth, upper bound on delay, jitter guarantees, upper bound on packet drop, and others. Priority traffic could be further classified in several categories, such as EF, FF, BE, etc. as supported by DiffServ. Based on the classification into traffic class based trunks—such aggregated traffic can be bundled into GRE encapsulated tunnels, if needed, for transport over IPX Provider networks.

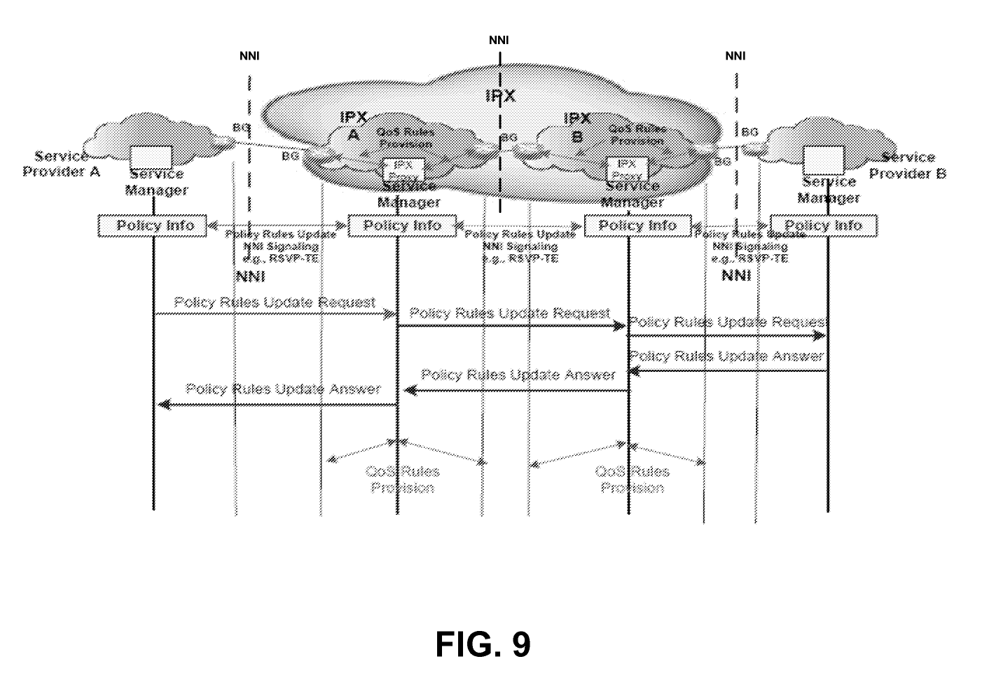

FIG. 8 shows an example of a proposed scalable IPX architecture that guarantees E2E QoS and leverages DiffServ and RSVP-TE-type of signaling. In the proposed architecture, at least one Service Manager (SM) function is provided as a QoS service manager and can be hosted in each Provider domain to manage and control QoS signals and operations. In the example illustrated in FIG. 8, four SM functions are provided in the service provider A network domain, the IPX A network domain, the IPX B network domain and the service provider B network domain, respectively. Each SM function is configured to manage QoS signaling in the respective communication network over network-to-network interconnections connecting the different communication networks and manages the QoS operations.

In the four different networks in FIG. 8, the service provider A network and the IPX A network interface with each other and are in direct communications with each other. Similarly, the IPX A network and the IPX B network interface with each other and the IPX B network and the service provider B network interface with each other. These are three pairs of interfacing networks in FIG. 8. The service provider A network and the IPX B network do not interface with each other and communicate via the IPX B network as an intermediary. Similarly, the service provider A network and the service B network, and the service provider B network and the IPX A network, do not interface with each other. The service provider A network and the service provider B network communicate via the IPX A and B networks.

In FIG. 8, a border gateway (BG) is provided in each communication network to interface with another interfacing communication network for signaling and data communications between the two interfacing communication networks. For a communication network interfacing with two other communication networks, for example, the IPX A network which interfaces with the service provider A network and the IPX B network has two border gateways that are designated to interface with the two other communication networks, respectively. Each border gateway, in addition as being a gateway to other network, is operated as a QoS policy enforcement entity to enforce the QoS policy.

In the architecture in FIG. 8, each IPX network domain includes an IPX proxy for SIP/SDP signals. The SM function for each IPX Provider domain in this illustrated example is shown hosted by the IPX Proxy in the IPX Provider domain. This is an example only and it is possible that Service Manager is hosted elsewhere in the IPX Provider domain. For example, such a Service Manager function can be hosted in the interfacing Service Provider (SP) domains as well. The SM in the IPX domain provides capabilities such as Bandwidth Broker (BB) and Policy Decision Point (PDP). The BB and PDP capabilities may be integrated within the SM in some implementations, or may be hosted elsewhere outside the SM within the respective IPX Provider domains. For QoS Over NNI interconnections, the SM in the Service Provider domain may not need the BB function. Bandwidth Broker can be a centralized Admission Control entity which manages network resources and policies in each domain. BB can have the visibility of all network resources, including link level loading status in the respective domain to facilitate efficient resource allocations and routing decisions. PDP can have policy information statically configured based on the SLAs, and such information can be configured and updated via Network Management Function. In some implementations, such policy information can be dynamically updated via inter-SM signaling.

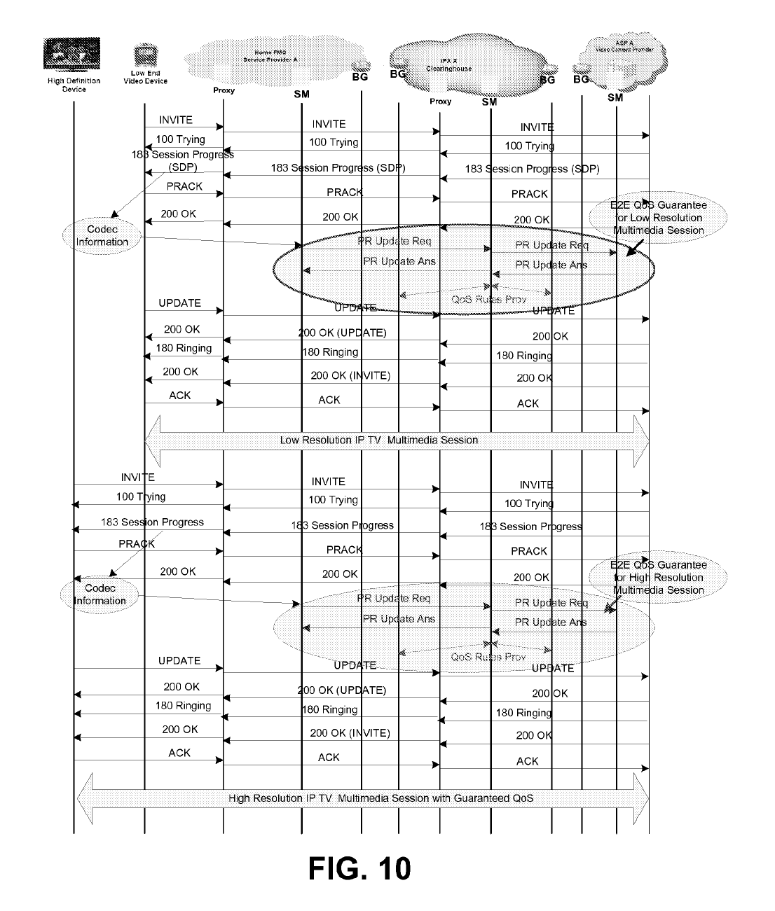

FIG. 9 shows an example of E2E QoS Guarantee Call Flows for the IPX architecture in FIG. 8. In this example, users in Service Provider A (SP-A) domain communicate with Users in Service Provider B (SP-B) domain via SIP signaling. On successful completion of SIP signaling, VoIP media flows E2E between the respective Users in SP-A and SP-B domains, provided admission control functions across the underlying transport network have successfully guaranteed E2E QoS for the media flows. In order to guarantee such E2E QoS for the transport of the media flows; SP-A and SP-B connect via the IPX network, with IPX-A and IPX-B providing NNI interconnects with SP-A and SP-B, respectively. Transport function across the interconnecting interfaces is provided via Border Gateways (BGs) at the edges of each domain. Service Manager is hosted by each of the SP-A, IPX-A, IPX-B and SP-B domains. The SMs have knowledge or information of the QoS components of the SLAs, including class based trunk bandwidth limitations etc. The SMs in the Service Provider domains also have knowledge or information of the bandwidth requirements for egress traffic belonging to different class trunks.

The SMs operate to signal the information on Policy Rules to the SMs in the interconnected SP and IPX Provider domains in a cascading fashion E2E. Such signaling includes resource requirements defined in terms of protocol-specific semantics and conveyed to the interfacing SMs with an agreed upon syntax. Resource requirements relate to bandwidth requirements for different class trunks, traffic characteristics in terms of upper bounds on delay, jitter guarantees, upper bound on packet loss etc., and other information as may be supported by the SLAs. As illustrated, the “Policy Rules Update” NNI Signaling is used for SM to SM communications on the Policy Rules.

An example of the above SM to SM signaling may be the RFC3209 RSVP-TE signaling with appropriate modifications in terms of syntax and semantics. RSVP-TE extensions and objects could be defined by the respective SDOs. The SDOs could define protocol(s) other than RSVP-TE as well for such Policy Rules Update NNI Signaling between the SMs. Based on the dynamic nature of the bandwidth requirements belonging to different traffic class trunks as signaled by an upstream SM; the receiving SM in the IPX domain communicates with its BB, which performs admission control to reserve appropriate bandwidth and other resources within its respective domain before committing to carry such traffic. For example, if SP-A wants to double ‘P1 Class’ of traffic that it exchanges with SP-B via the IPX; protocol-specific Policy Rules Update NNI Signaling from SP-A to IPX-A, and cascaded from IPX-A to IPX-B and from IPX-B to SP-B ensures reservation of the required bandwidth and other resources E2E before SP-A is allowed to double such ‘P1 Class’ of traffic entering IPX-A over NNI.

Agreed upon policy decisions at the SM are enforced via intra-domain QoS Rules Provision Signaling with the Border Gateways (BGs). BGs are the policy enforcement entities (PEP). Such signaling includes QoS requests defined in terms of protocol-specific QoS semantics and communicated between the SM and the BG with an agreed upon QoS syntax. Examples of such signaling include IETF RSVP, RSVP-TE, 3GPP PCC, ETSI TISPAN RACS etc. with appropriate modifications in terms of syntax and capabilities.

Within an IPX Provider domain, the SM communicates with the BGs that sit at the edges of its network. Policing and policy enforcement by the BGs are used to ensure that traffic egress from a Provider domain conforms to the agreed traffic characterization and capacity. A simple example of such a mechanism would be a token bucket system implemented on a per trunk basis. Similarly, the ingress Provider receiving the trunks of traffic needs to ensure that the received traffic is in compliance with the SLAs.

The SM communicates with the BGs at the edges of its respective domain by using “QoS Rules Provision” signaling as shown in FIG. 9. On receiving a Policy Rules Update Request (PR-R) NNI message indicating Resource Reservation (RR) request from a peer-SM, the SM in the IPX domain checks with its BB for the availability of resources within its respective domain, and, if resources are available, the SM marks the resources for reservation before forwarding the PR-R to the next SM in the cascaded chain towards the destination SP. Intra-domain SM-BB communications could be via SNMP or another suitable protocol. In case the admission control decision is negative, a failure answer is sent to the originating SM. Once the required resources are available E2E, the returning Policy Rules Update Answer (PR-A) chain of messages can be used for the actual reservation of the resources. Other possible approaches include using a separate set of signaling between the SMs for the actual reservation of the resources.

Policing and policy enforcement at the BGs includes SMs using “QoS Rules Provision” protocol to communicate QoS Rules and enforcement decisions to their respective BGs. The flow specifications within the QoS Rules Provision signaling describe the characteristics of the class based trunks. Such “Policy Rules Update” and “QoS Rules Provision” signaling between architectural functional entities are illustrated in FIG. 9.

In some implementations, an E2E QoS over NNI in IPX architecture can be based on the following elements: Service Level Agreements (SLAs) amongst the interconnected domains, DiffServ markings on traffic trunks based on agreed upon classification criterion, Inter-domain SM-SM NNI signaling for the exchange of policy and resource requirements in a cascaded manner E2E, Intra-domain SM-BB communications for admission control and resource allocations could be via SNMP or another suitable protocol, and Intra-domain SM-BG signaling for the enforcement of policy based on agreed policy and DiffServ markings on traffic trunks.

### First Example for Implementing E2E QoS Over NNI Solution

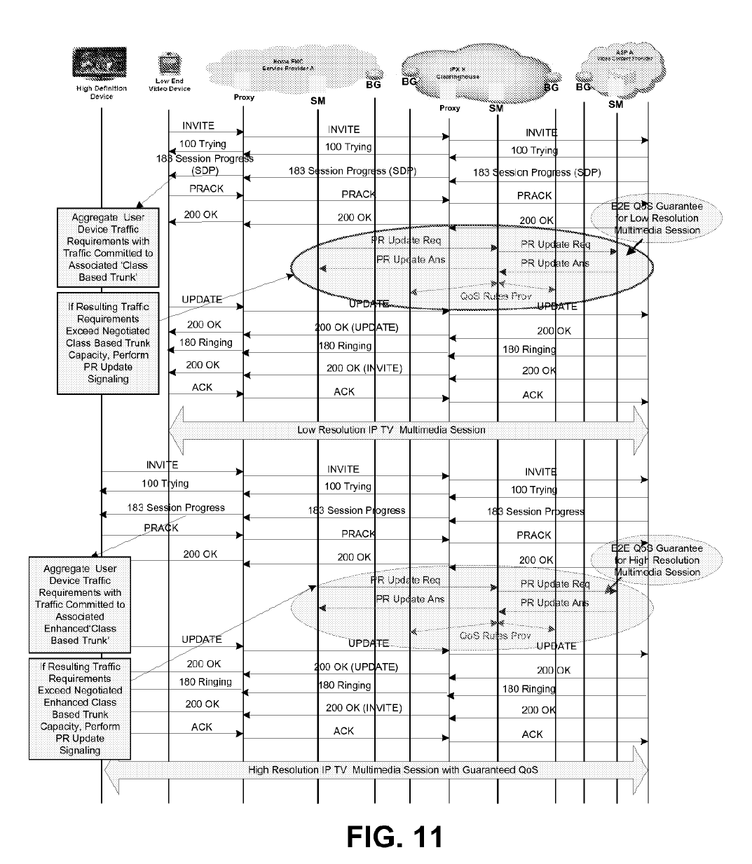

As an example, referring back to the scenario in FIG. 7 for a User subscribed to home broadband and premium video services from an FMC Home Provider A. It is assumed that a solution exists for ensuring E2E QoS guarantees to the User, irrespective of which user device is used for accessing the services. The call flows in FIG. 10 illustrate one exemplary method for achieving QoS over NNI based on FIGS. 8 and 9. This particular method is based on the SLAs that Home Provider A and ASP A maintain with the IPX Clearinghouse IPX X. The codes for signaling messages in FIG. 10 are SIP status codes used in IPX.

The call flows in FIG. 10 show that the User initially watches IPTV via a low resolution wireless device. Home Provider A and ASP A recognize access device capabilities. ASP A encodes the media streams according to User wireless device's low resolution capabilities. Provider A also takes actions to signal user device capabilities in terms of bandwidth requirements and traffic characteristics etc. to IPX X Clearinghouse via ‘Policy Rules Update’ Request (PR-Request) NNI signaling. The Service Manager (SM) functions in the Provider A, IPX X and ASP A perform inter-domain SM-SM signaling for the allocation and reservation of resources in the IPX X domain. The SM in the IPX X domain then performs intra-domain SM-BG signaling for the enforcement of the E2E QoS requirements at the Border Gateways. On completion of successful SIP signaling for the establishment of the IPTV session, ASP A sends appropriately encoded and DiffServ marked media streams to the User via the clearinghouse IPX X. E2E QoS for such media streams is guaranteed by virtue of the bandwidth reservations and enforcement of the SLAs between the carriers.

The user then switches to a high resolution device, e.g., via the landline access. Home Provider A and ASP A again recognize User access device capabilities. ASP A encodes the media streams according to User home device's high resolution capabilities. Provider A again takes actions to signal user device capabilities in terms of the enhanced bandwidth requirements and traffic characteristics etc. to the clearinghouse IPX X via ‘Policy Rules Update’ Request (PR-Request) NNI signaling. The Service Managers (SMs) in the Provider A, IPX X and ASP A perform inter-domain SM-SM signaling for the allocation and reservation of the resources in the IPX domain. The SM in the IPX domain then performs intra-domain SM-BG signaling for the enforcement of enhanced E2E QoS requirements at the Border Gateways. On successful completion of SIP signaling, ASP A sends appropriately encoded and DiffServ marked media streams to the User via the clearinghouse IPX X. E2E QoS for such media streams is again guaranteed by virtue of bandwidth reservations and enforcement of the SLAs between the carriers.

FIG. 10 shows exemplary call flows for session and connection establishment for QoS-guaranteed multimedia services. In particular, FIG. 10 shows examples of Call Flows associated with Guaranteeing E2E QoS Over NNI for Multi Device Access. In this example, the User (caller) invokes a low resolution IPTV session with ASP A IPTV server (callee) through SIP:INVITE request. Intermediate SIP Proxies deliver the SIP messages E2E between the caller and the callee. Within the INVITE message created by the caller, the message body includes information regarding the characteristics of the caller device. Such information includes Session Description Protocol (SDP) contents related to media handing capabilities, QoS requirements, security etc. On receiving the INVITE, the callee analyzes SDP information and checks the requested and supported media, QoS requirements etc. The callee then sends response message (e.g., a 183 Session Progress Response) to the caller. Here the callee (Application Service Provider) specifies the services, media types and QoS available to the User that correspond to the request in the INVITE message. On receiving the 183 message, if the caller can accommodate callee's offerings, the caller sends PRACK (Provisional Response ACKnowledgment) message to the callee as response to the 183 message. If not, the caller notifies failure of session establishment to callee. Callee receives PRACK and responds with a 200 OK message.

In parallel with sending PRACK to the callee, the Service Manager (SM) in Provider A domain initiates NNI signaling with the SM in the clearinghouse IPX X domain for the reservation of bandwidth and other resources E2E toward ASP A domain. SM in Provider A domain receives information on the agreed upon media requirements for this call via interactions with the SIP Proxy in its domain. Such SIP Proxy and SM functions may be collocated or placed anywhere in the respective domains. Syntax and semantics of the protocol used for communications between SIP Proxy and the SM within a provider domain could be proprietary or standardized. Policy Rules Update Request NNI signaling between the SMs in Provider A, IPX X and ASP A domains result in the allocation and reservation of the resources E2E per SLAs between such domains. The SM in the IPX domain then performs intra-domain SM-BG QoS Rules Provision signaling with the Border Gateways for the enforcement of E2E QoS requirements.

After completion of bandwidth reservations and enforcement related signaling, the caller and the callee exchange the rest of SIP messages (UPDATE, Ringing, 200 OK, ACK) so the IPTV session can progress further. Low Resolution real-time media streams can be provided to user wireless device with guaranteed QoS E2E.

Later, when the User switches to a high resolution multimedia device, similar SIP: signaling happens between the User (caller) and the ASP A IPTV Server (callee). High Resolution multimedia requirements are exchanged and agreed upon between the caller and the callee, with the callee sending 183 Session Progress Response to the caller. The Application Service Provider (callee) specifies the high resolution media types and QoS available to the User that correspond to such request in the INVITE message. On receiving the 183 message, if the caller can accommodate callee's offerings, the caller sends PRACK message to the callee as response to 183 message. If not, the caller notifies failure of session establishment to the callee. Callee receives PRACK and responds with 200 OK message.

In parallel with sending PRACK to the callee, the Service Manager (SM) in Provider A domain initiates NNI signaling with the SM in the IPX X domain for the reservation of enhanced bandwidth and other resources E2E toward ASP A domain. SM in Provider A domain receives information on the agreed upon high resolution media requirements for this call via interactions with the SIP Proxy function in its respective domain. Policy Rules Update Request NNI signaling between the SMs in Provider A, IPX X and ASP A domains result in the allocation and reservation of high bandwidth resources E2E per SLAs between such domains. The SM in the IPX domain then performs intra-domain SM-BG QoS Rules Provision signaling with the Border Gateways for the enforcement of enhanced E2E QoS requirements.

After completion of high bandwidth resource reservation and enforcement related signaling, the caller and the callee exchange the rest of SIP messages (UPDATE, Ringing, 200 OK, ACK) so the IPTV session can progress further. High Resolution real-time media streams can now the provided to user wireless device, with guaranteed QoS E2E.

### Second Example for Implementing E2E QoS Over NNI Solution

FIG. 11 shows call flows of another method based on FIGS. 8 and 9 for QoS over NNI in the scenario in FIG. 7 for a User subscribed to home broadband and premium video services from an FMC Home Provider A. The method is based on the SLAs that Home Provider A and ASP A maintain with the IPX Clearinghouse IPX X.

The call flows in FIG. 11 show the User initially watches IPTV via a low resolution wireless device. Home Provider A and ASP A recognize access device capabilities. ASP A encodes the media streams according to User wireless device's low resolution capabilities.

Provider A takes note of user device capabilities in terms of low resolution bandwidth and traffic characteristics etc., and classifies such user device capabilities to one of the ‘class based trunks’ in the SLA over NNI negotiated with IPX-X. Provider A aggregates user device low resolution bandwidth and QoS requirements with the user traffic already reserved/committed to the class based trunk.

If the resulting aggregated traffic requirement for the class based trunk is within the negotiated class based trunk traffic limitations; on completion of successful SIP signaling for the establishment of the IPTV session, ASP A proceeds with sending appropriately encoded and DiffServ marked media streams to the User via the clearinghouse IPX X.

If, however, the resulting aggregated traffic requirement for the class based trunk exceeds the negotiated class based trunk traffic limitations, Provider A takes actions to signal increased traffic requirements for the class based trunk to the IPX X Clearinghouse via ‘Policy Rules Update’ Request (PR-Request) NNI signaling. The Service Manager (SM) functions in the Provider A, IPX X and ASP A perform inter-domain SM-SM signaling for the allocation and reservation of resources to the class based trunk in the IPX X domain. The SM in the IPX X domain then performs intra-domain SM-BG signaling for the enforcement of the E2E QoS requirements at the Border Gateways. On completion of successful SIP signaling for the establishment of the IPTV session, ASP A sends appropriately encoded and DiffServ marked media streams to the User via the clearinghouse IPX X. E2E QoS for such media streams is guaranteed by virtue of the bandwidth reservations and enforcement of the SLAs between the carriers.

The user then switches to a high resolution device via landline access. Home Provider A and ASP A again recognize User access device capabilities. ASP A encodes the media streams according to User home device's high resolution capabilities.

Provider A again takes note of user device capabilities in terms of enhanced bandwidth and traffic characteristics etc., and classifies such user device capabilities to one of the ‘enhanced class based trunks’ in the SLA over NNI negotiated with IPX-X. Provider A aggregates user device enhanced bandwidth and QoS requirements with the user traffic already reserved/committed to the enhanced class based trunk.

If the resulting aggregated traffic requirement for the enhanced class based trunk is within the negotiated class based trunk traffic limitations; on completion of successful SIP signaling for the establishment of the IPTV session, ASP A proceeds with sending appropriately encoded and DiffServ marked media streams to the User via the clearinghouse IPX X.

If, however, the resulting aggregated traffic requirement for the enhanced class based trunk exceeds the negotiated class based trunk traffic limitations, Provider A takes actions to signal increased traffic requirements for the class based trunk to the IPX X Clearinghouse via ‘Policy Rules Update’ Request (PR-Request) NNI signaling. The Service Manager (SM) functions in the Provider A, IPX X and ASP A perform inter-domain SM-SM signaling for the allocation and reservation of resources to the class based trunk in the IPX X domain. The SM in the IPX X domain then performs intra-domain SM-BG signaling for the enforcement of the E2E QoS requirements at the Border Gateways. On completion of successful SIP signaling for the establishment of the IPTV session, ASP A sends appropriately encoded and DiffServ marked media streams to the User via the clearinghouse IPX X. E2E QoS for such media streams is guaranteed by virtue of the bandwidth reservations and enforcement of the SLAs between the carriers.

FIG. 11 shows examples of call flows for session and connection establishment for QoS-guaranteed multimedia services. In particular, FIG. 11 shows examples of Call Flows associated with Guaranteeing E2E QoS Over NNI for Multi Device Access. In this example, the User (caller) invokes a low resolution IPTV session with ASP A IPTV server (callee) through SIP:INVITE request. Intermediate SIP Proxies deliver the SIP messages E2E between the caller and the callee. Within the INVITE message created by the caller, the message body includes information regarding the characteristics of the caller device. Such information includes SDP contents related to media handing capabilities, QoS requirements, security etc. On receiving the INVITE, the callee analyzes SDP information and checks the requested and supported media, QoS requirements etc. The callee then sends response message (183 Session Progress Response) to the caller. Here the callee (Application Service Provider) specifies the services, media types and QoS available to the User that correspond to the request in the INVITE message. On receiving the 183 message, if the caller can accommodate callee's offerings, the caller sends PRACK (Provisional Response ACKnowledgment) message to the callee as response to 183 message. If not, the caller notifies failure of session establishment to callee. Callee receives PRACK and responds with 200 OK message.

If needed, due to exceeding the aggregated traffic requirements for the low resolution class based trunk; in parallel with sending PRACK to the callee, the Service Manager (SM) in Provider A domain can initiate NNI signaling with the SM in the clearinghouse IPX X domain for the reservation of more E2E bandwidth and other resources for the class based trunk towards ASP A domain. SM in Provider A domain receives information on the agreed upon media requirements for this class based trunk via interactions with the SIP Proxy in its domain. Such SIP Proxy and SM functions may be collocated or placed anywhere in the respective domains. Syntax and semantics of the protocol used for communications between SIP Proxy and the SM within a provider domain could be proprietary or standardized. Policy Rules Update Request NNI signaling between the SMs in Provider A, IPX X and ASP A domains result in the allocation and reservation of more resources E2E for class based trunk per SLAs between such domains. The SM in the IPX domain then performs intra-domain SM-BG QoS Rules Provision signaling with the Border Gateways for the enforcement of E2E QoS requirements.

After completion of bandwidth reservations and enforcement related signaling, if required, the caller and the callee exchange the rest of SIP messages (UPDATE, Ringing, 200 OK, ACK) so the IPTV session can progress further. Low Resolution real-time media streams can now the provided to user wireless device with guaranteed QoS E2E.

Later, when the User switches to a high resolution multimedia device, similar SIP: signaling happens between the User (caller) and the ASP A IPTV Server (callee). High Resolution multimedia requirements are exchanged and agreed upon between the caller and the callee, with the callee sending 183 Session Progress Response to the caller. The Application Service Provider (callee) specifies the high resolution media types and QoS available to the User that correspond to such request in the INVITE message. On receiving the 183 message, if the caller can accommodate callee's offerings, the caller sends PRACK message to the callee as response to 183 message. If not, the caller notifies failure of session establishment to the callee. Callee receives PRACK and responds with 200 OK message.

If needed, due to exceeding the aggregated traffic requirements for the enhanced class based trunk; in parallel with sending PRACK to the callee, the Service Manager (SM) in Provider A domain can initiate NNI signaling with the SM in the clearinghouse IPX X domain for the reservation of more E2E bandwidth and other resources for the enhanced class based trunk towards ASP A domain. SM in Provider A domain receives information on the agreed upon media requirements for the enhanced class based trunk via interactions with the SIP Proxy in its domain. Such SIP Proxy and SM functions may be collocated or placed anywhere in the respective domains. Syntax and semantics of the protocol used for communications between SIP Proxy and the SM within a provider domain could be proprietary or standardized. Policy Rules Update Request NNI signaling between the SMs in Provider A, IPX X and ASP A domains result in the allocation and reservation of more resources E2E for the enhanced class based trunk per SLAs between such domains. The SM in the IPX domain then performs intra-domain SM-BG QoS Rules Provision signaling with the Border Gateways for the enforcement of E2E QoS requirements.

After completion of high bandwidth resource reservation and enforcement related signaling, the caller and the callee exchange the rest of SIP messages (UPDATE, Ringing, 200 OK, ACK) so the IPTV session can progress further. High Resolution real-time media streams can now the provided to user wireless device, with guaranteed QoS E2E.

### Additional Examples:

Multiple wireless or wireline communication systems can provide end-to-end (E2E) QoS. In some implementations, a wireless or wireline communication system can use a mechanism to operate IPX to carry service awareness information from one carrier to another in a cascading manner. Service awareness information can include service provider requirements such as QoS, security, and charging. For example, a wireless communication system can operate an inter-carrier IP interconnection to exchange policy rules. An inter-carrier IP interconnection can be based on one of multiple modes such as (1) a transport only mode wherein the IP Interconnect relays IP traffic from one carrier to the another, (2) a service transit mode wherein in addition to relaying the IP traffic, the IP Interconnect carrier (IPX) has ‘service awareness’ and can treat traffic accordingly, and (3) a hubbing mode wherein the IP Interconnect carrier relays the IP traffic to multiple service providers, and provides ‘service awareness’ also. In some implementations, an IPX can provide an ‘IPX Proxy’ function. An IPX Proxy can include SIP proxy capabilities.

Wireless or wireline communication systems can transmit and forward voice and data based on service level agreements (SLAs). In some implementations, service providers and IPX carriers can have one or more SLAs. Correspondingly, different carriers within the IPX can have SLAs. SLAs can include policy information such as the expected treatment for traffic belonging to various classes to/from each other.

A service provider can classify egress traffic into different classes, such as best effort, priority, mission critical etc. Such classification can be based on traffic characteristics such as priority for bandwidth, delay, jitter tolerance, packet drop sensitivity etc. Priority traffic can be further classified in several categories, such as EF, FF etc. as provided by Diffserv.

In some implementations, the above described classification of traffic can be based on the aggregate of flows from a service provider egress point to the IPX—and not on an individual call basis. Based on such classification into different ‘classes’—SLAs can be created to enforce the expected treatment by the receiving carrier based on Diffserv markings.

In some implementations, IPX can support Multiprotocol Label Switching (MPLS). A MPLS framework can support transport of traffic across an IPX network.

Some implementations can use RFC 3209 RSVP-TE signaling between different routing/transport entities in the service provider and IPX networks. RSVP-TE signaling provides for the exchange of LABEL—Request and Explicit_Route objects amongst the MPLS LSPs, and convey the traffic characteristics/class information E2E, thereby ensuing E2E bandwidth to meet traffic ‘class’ requirements. The ‘class’ requirements are carried via Diffserv/CoS markings.

Some implementations can use Diffserv of IPX and can leverage the capabilities provided by RFC 3209 RSVP-TE. In some implementations, an IPX Proxy can host a ‘Service/Traffic/Policy Manager’ function. A Service Manager (SM) can be hosted by the Service Provider (SP) network also (that interfaces/interconnects with IPX). The SM is the policy manger and communicates with the SMs in the interconnected SP/IPX Carrier networks. RSVP-TE type of signaling can be used for exchanging policy information, traffic information, traffic characteristics etc., between SMs in a cascading fashion end-to-end. It may be noted that the policy information etc. exchanged between the SMs can be similar to the information in the SLAs between the interconnected carriers. Based on the dynamic nature of the traffic belonging to different ‘classes’, the SMs can reserve resources/bandwidth E2E before committing to certain classes of services. For example, if SP-S, suddenly wants to double ‘P-1 class’ of traffic that it exchanges with SP-D via IPX-X; RSVP-TE type of signaling from SM-S to SM-X, and then cascaded from SM-X to SM-D will ensure reservation of the required bandwidth E2E before SP-S is allowed to double such P-1 traffic entering IPX-X.

In some implementations, within a particular network, the SM can communicate with a Border Function (BF) that sits at the edge of its network. BFs are policy enforcement entities. SM communicates with the BFs at the edge of its respective network using a protocol similar to (or a derivate of) RSVP-TE, or another agreed upon protocol. On receiving a message indicating resource reservation (RR) request from a peer-SM, the SM checks for availability of resources within its respective network, and possibly marks the resources for reservation, before forwarding resource reservation (RR) request to the next SM in the cascaded chain towards the destination SP. Once the required resources are available E2E, the returning RR - reply chain of messages can be used for the actual reservation of the resources.

Other implementations, such as the use of a separate set of signaling between SMs for the actual reservation of resources can also be considered. Actual resource reservation and enforcement includes SMs communicating QoS Rules and enforcement decision(s) to their respective BFs—using agreed upon protocols and signaling.

In some implementations, traffic exchanged over NNIs is Diffserv marked. The agreed upon policy and rules are enforced by the BF entities based on the Diffserv marking on the aggregate of traffic belonging to the respective ‘classes’. In some implementations, E2E policy exchange and resource reservations can be performed by SM-SM signaling. E2E QoS on aggregate of traffic classes based on Diffserv markings can be enforced via SM-BF signaling. A solution can include SLAs, Diffserv markings on traffic class aggregates, SM-SM signaling, and SM-BF signaling.

The disclosed and other embodiments and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is what is described and illustrated, including:

1. A method for providing quality of service (QoS) in packet data communications via different communication networks, comprising:
providing QoS service managers in different communication networks, respectively, to manage QoS signaling in the different communication networks over network-to-network interconnections connecting the different communication networks;
operating the QoS service managers of two interfacing different communication networks to communicate with each other to enable each QoS service manager to obtain QoS information of a Service Level Agreement (SLA) for a data communication service supported by the different communication networks and information on network communication resource in a respective communication network;
providing a border gateway in each communication network to interface with another interfacing communication network for signaling and data communications between the two interfacing communication networks, wherein a communication network interfacing with two other communication networks, if exists, has two border gateways that are designated to interface with the two other communication networks, respectively;
operating each QoS service manager to communicate to one or more border gateways in a respective communication network information on QoS policy for the data communication service including the QoS information of the SLA and the information on network communication resource for the data communication service; and
operating each border gateway as a QoS policy enforcement entity to enforce the QoS policy.

2. The method as in claim 1, comprising:
operating a first QoS service manager on one of the different communication works to send out a request for QoS update for the data communication service to a second QoS service manger in another interfacing communication network;
operating the second QoS service manger in the other interfacing communication network to obtain information on the requested QoS update and to send a reply to the first QoS service manger; and
operating the first QoS service manger to inform the QoS update to one or more respective border gateways in the respective communication network information.

3. The method as in claim 2, comprising:
when the request for QoS update for the data communication service includes a condition that is not met based on information at the second QoS service manger, operating the second QoS service manger in the other interfacing communication network to include in reply a message indicating that the condition is not met.

4. The method as in claim 3, further comprising:
operating the second QoS service manger not to send a further request for the QoS update to another interfacing communication network.

5. The method as in claim 2, comprising:
when the request for QoS update for the data communication service includes a condition that is met based on information at the second QoS service manger, operating the second QoS service manger in the other interfacing communication network to send a second request for the QoS update to a third QoS service manger in a third communication network that interfaces with the second communication network and involves in the data communication service to obtain the requested update from the third QoS service manger; and
after obtaining the requested update from the third QoS service manger, operating the second QoS service manger to send the reply to the first QoS service manager based on the requested update from the third QoS service manger.

6. The method as in claim 1, comprising:
operating one of the QoS service managers in the different communication networks that support the data communication service to adjust a communication bandwidth of a respective communication network based on a requirement in the Service Level Agreement (SLA) for the data communication service.

7. The method as in claim 1, wherein:
one of the different communication networks is a wireless network to provide data services to wireless devices.

8. The method as in claim 1, wherein:
one of the different communication networks is a wired network to provide data services via one or more wired communication links.

9. The method as in claim 1, wherein:
one of the different communication networks is a wireless network to provide data services to wireless devices.

10. The method as in claim 1, wherein:
the different communication networks include a wired network to provide data services via one or more wired communication links and a wireless network to provide data services to wireless devices.

11. A method for wireless or wireline communications, comprising:
exchanging policy rule information between one or more networks to provide end-to-end quality-of-service for one or more connections between different service providers.

12. The method of claim 11, further comprising:
communicating policy rule information to a network router to control the network router to enforce one or more policy rules.
